(19) United States
(12) Patent Application Publication
(10) Pub. No.: US 2007/0268251 A1
(43) Pub. Date: Nov. 22, 2007

(54) Joystick controller

(76) Inventor: Wayne Edmunds, Risca (GB)

Correspondence Address: WELLS ST. JOHN P.S., 601 W. FIRST AVENUE, SUITE 1300, SPOKANE, WA, 99201, US

(21) Appl. No.: 11/711,262

(22) Filed: Feb. 26, 2007

(30) Foreign Application Priority Data
Feb. 28, 2006 (GB) 0603925.9

(51) Int. Cl. G06F 3/033

(52) U.S. Cl. 345/161

(57) ABSTRACT

A joystick controller comprises an operating shaft mounted for pivotal movement relative to a body. The operating shaft extends through an opening in the body. A bush is coupled to the operating shaft and biased into contact with a contact surface of the body so as to provide a force resisting movement of the operating shaft away from a null position. The contact surface has a form configured to provide a change in the resistive force that increases linearly with an increase in angle of displacement of the operating shaft away from the null position.

The present invention relates to a joystick controller. More particularly, the present invention relates to a joystick controller having an improved centre-return mechanism.

It is known for joystick controllers to include a centre-return mechanism whereby when the joystick operating shaft or lever is released it automatically returns to a null or centre position. For two-direction, or two-degree of freedom joysticks, the centre-return mechanism may consist of an annular bush or cone member mounted around a cylindrical portion of the operating shaft. The cone member is biased by a helical spring into contact with a seat surface that surrounds an opening (gate) in the joystick body through which the operating shaft extends. As the operating shaft is displaced away from the centre position the cone member is urged up the shaft by the contact between the cone member and the seat, thereby compressing the helical spring.

One problem with this arrangement is that the size of the centre-return force can vary in an unpredictable manner depending on the amount or direction of the displacement of the operating shaft. A further problem arises because the contacting surfaces between the cone member and the seat tend to wear and this in turn affects the centre-return force.

It is an object of the present invention to provide an improved joystick controller in which the aforementioned problems are alleviated.

According to a first aspect of the present invention there is provided a joystick controller comprising an operating shaft mounted for pivotal movement relative to a body, the operating shaft extending through an opening in the body, and a bush coupled to the operating shaft and biased into contact with a contact surface of the body so as to provide a force resisting movement of the operating shaft away from a null position, wherein the contact surface has a form configured to provide a change in the resistive force that increases linearly with an increase in angle of displacement of the operating shaft away from the null position.

In a preferred embodiment, the null position is a central position, the operating shaft being mounted for pivotal movement in either direction away from the null position. The operating shaft may be mounted for pivotal movement about two orthogonal pivot axes and the contact surface may have a form that provides for a linear increase in the resistive force in whichever direction the operating shaft is displaced. The joystick controller may be configured to allow the operating shaft to be displaced up to a maximum extent simultaneously in each of the orthogonal directions, such that the full range of movement of the operating shaft covers a rectangular (or square) area. The contact surface may be configured to provide an increase in the resistive force that varies linearly with angle in any direction.

It is an advantage that, by configuring the contact surface so that the resistive force varies directly with the change in displacement angle of the operating shaft, a user is provided with reliable tactile feedback as to the extent of displacement of the operating shaft.

According to a second aspect of the present invention there is provided a joystick controller comprising an operating shaft mounted for pivotal movement relative to a body, the operating shaft extending through an opening in the body, and a bush coupled to the operating shaft, and biased into contact with a contact surface of the body so as to provide a force resisting movement of the operating shaft away from a null position, wherein the bush comprises a first portion of a first material in slideable engagement with the operating shaft and a second portion of a second material for contacting the contact surface.

Preferably the first material is selected to have a low coefficient of friction with the operating shaft. More preferably, the second material is selected to have material properties that provide a high resistance to shear and compressive forces so as to reduce wear.

The two-material bush offers significant advantages in prolonging the useful life of the controller by providing a hardwearing material for contacting the contact surface and a low friction material to ensure that the bush slides freely on the operating shaft.

Embodiments of the invention will now be described by way of example with reference to the accompanying drawings, in which:

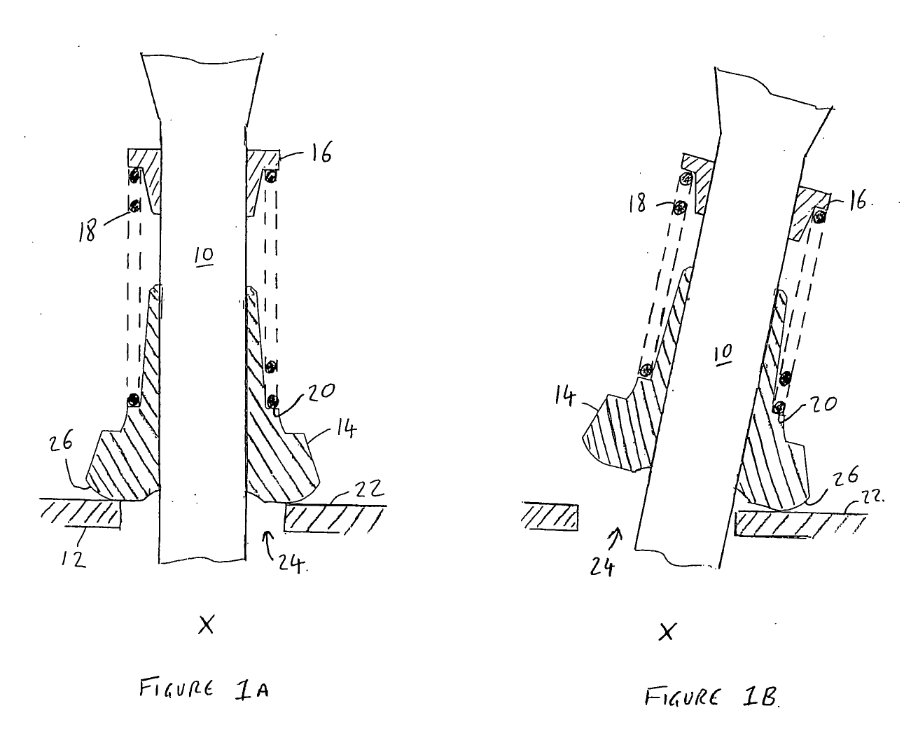

FIGS. 1A and 1B show two positions of part of an operating shaft and return-to-centre mechanism of a known joystick controller;

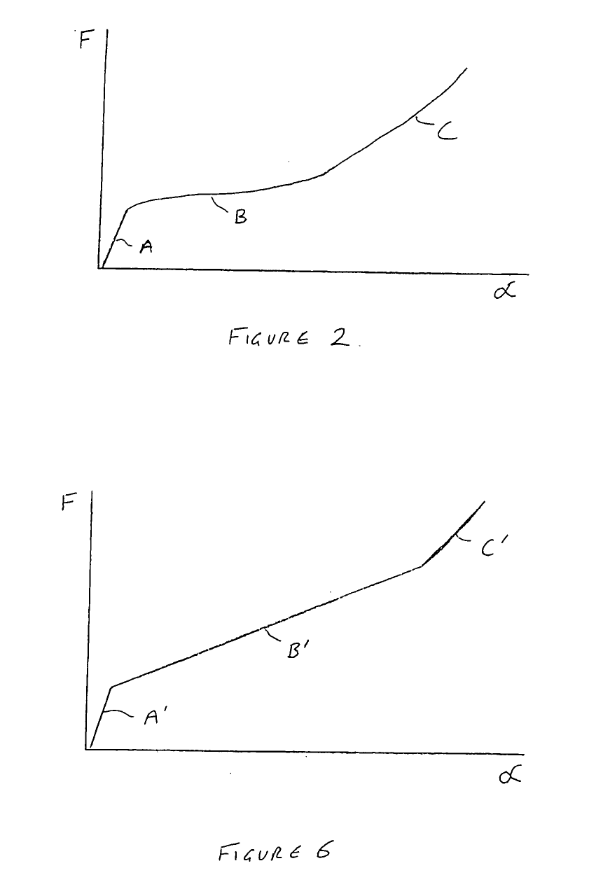

FIG. 2 is a graph showing resistive force as a function of angle of displacement of the operating shaft for the known joystick controller of FIG. 1;

FIG. 3 shows, in cross-section, a sliding cone member forming part of a joystick controller in accordance with the invention;

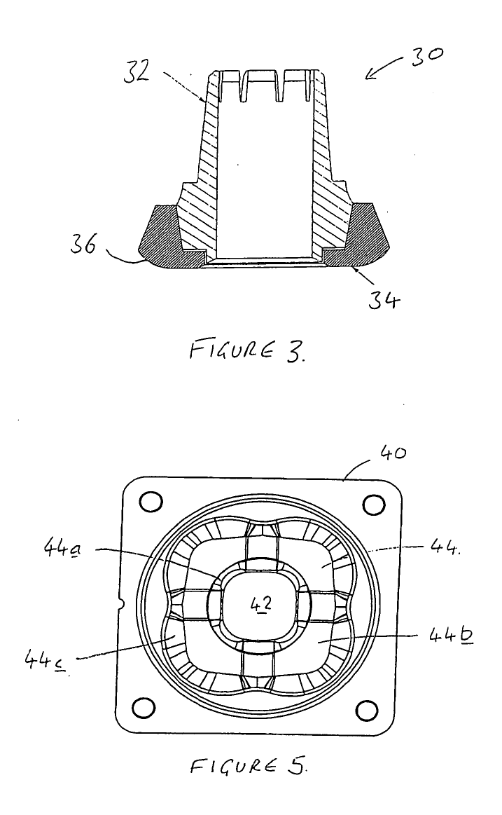

FIG. 4 shows, in cross-section, a seat member forming part of a joystick controller in accordance with the invention;

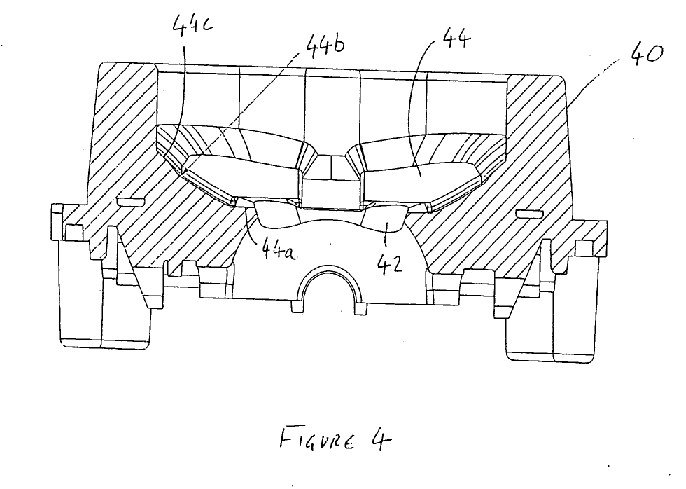

FIG. 5 is a plan view from above of the seat member of FIG. 4;

FIG. 6 is a graph showing resistive force as a function of angle of displacement of the operating shaft for a joystick controller constructed using the components depicted in FIGS. 3 to 5.

Referring to FIGS. 1A and 1B, in a known arrangement, a joystick controller has an operating shaft 10, which is mounted for pivotal movement relative to a body 12 (only part of which is shown) about a pivot centre X. The pivotal movement may be provided by means of a ball and socket arrangement or by other means such as gimbals mounted for pivotal movement about an axis.

The joystick controller has a return-to-centre mechanism 11, which includes an annular bush or cone member 14 mounted so as to be able to slide up and down the operating shaft 10. An abutment 16 is fixed to the operating shaft 10 above the cone member 14. A helical compression spring 18 extends between the abutment 16 and an upward facing location surface 20 on the cone member 14.

The body 12 includes an upper surface 22. The operating shaft extends through an opening 24 in the upper surface 22 such that the pivot centre X is below the opening and the return-to-centre mechanism 11 is above the opening. The cone member 14 has a lower surface 26, which abuts the upper surface 22 of the body 12. As can be seen in FIG. 1B, when the operating shaft 10 is tilted relative to the body 12, the lower surface 26 of the cone member 14 is urged into contact with one side of the upper surface 22 of the body 12, and lifts away from the upper surface 22 at the other side. As a consequence, the cone member 14 slides up the operating shaft 10 and compresses the spring 18. The compression of the spring provides a resistive force that acts through the point of contact between the lower surface 26 of the cone member 14 and the upper surface 22 of the body 12. This resistive force is out of alignment with the pivot centre X and so provides a moment that acts against the force used (by the user's hand) to tilt the operating shaft 10. Thus, when the user releases the operating shaft 10, the moment acts to return the operating shaft to its central, or null position—the position shown in FIG. 1B.

FIG. 2 is a graph showing the size of the resistive force F as a function of the angle of displacement α of the operating shaft 10. There is an initial steep rise A in the force required to commence movement of the operating shaft 10 from its central or null position. This is the force required to overcome static friction in the spring and pivot mechanisms. After that, the force increases gradually B, C as the angle of displacement (tilt) is increased. In general, the increase in force is slight (B) for relatively small displacement angles but increases more rapidly (C) for larger angles.

The users of this type of joystick controller will frequently rely on a degree of tactile feedback and will learn to gauge the amount of displacement from the strength of the resistive force on the operating shaft 10. However, when the displacement angle is relatively small, in the region B of FIG. 2, the change in the strength of resistive force is slight and the users find it difficult to use this as a reliable tactile feedback.

Another difficulty with controllers of the type shown in FIGS. 1A and 1B is that the cone member 14 needs to be formed from a low-friction material so that it slides freely on the operating shaft 10. However, such materials seldom have good wear properties. In use, the lower surface 26 of the cone member 14 can be subjected to large shear and compressive forces, which will tend to cause the cone material to wear. A significant amount of wear will alter the resistive force characteristics and upset the tactile feedback, especially if the wear to the lower surface 26 is greater on one side of the cone member 14 than on another side.

FIG. 3 shows a cone member 30 suitable for use in the joystick controller of the present invention. The cone member 30 includes an upper portion 32 of a material having a low coefficient of friction such that it slides freely on the operating shaft. The cone member 30 also includes a lower portion 34 fixed to the upper portion 32, and formed of a material having high resistance to shear and compressive forces. The lower portion 34 has much better wear resistance than the material of the upper portion 32. The lower portion 34 has a lower contact surface 36, of similar form to the lower contact surface 26 of FIGS. 1A and 1B.

FIG. 4 shows a cross-section through an upper body member 40 of a joystick controller. For clarity, the operating shaft and all other components of the joystick have been omitted. The upper body member 40 has a central gate opening 42 through which an operating shaft would extend in a similar manner to that described above with reference to FIGS. 1 and 2. The upper body member 40 also has a generally upwardly facing seat contact surface 44, which is the surface against which a cone member (such as the cone member 30 of FIG. 3) is urged when the operating shaft is moved. As can be seen, the contact surface 44 has three regions: a flat inner region 44a, a mid-region 44b, which curves upwards with increasing distance from the centre, and an outer region 44c which has a steep upward slope. For reasons that will be explained in more detail below, the three regions 44a, 44b, 44c are not annular in shape when viewed from above, but extend further in some directions than others (forming a “clover-leaf” shape as can be seen in FIG. 5).

As can be seen in FIG. 5, which is a plan view of the upper body member 40, the gate 42 has a square form with rounded corners. The rounded corners have a radius that corresponds to the radius of the operating shaft (not shown). This form provides the ability for the operating shaft of the joystick controller to be moved to any position within a square area. Put another way, the square gate opening 42 allows for pivotal movement in two orthogonal directions (x and y) up to a maximum displacement in both the x and y directions simultaneously. Clearly the angle of displacement of the operating shaft (i.e. the angle to the vertical, assuming the joystick is mounted to a horizontal surface) will be greatest when displaced to the maximum in both the x and y directions. For this reason, the seat contact surface 44 is provided with a corresponding form that matches the square form of the gate opening 32. However, the seat contact surface is not square, but has rounded corners to account for the fact that the cone member (such as cone member 30), which contacts the seat contact surface 34 is of annular form, having a circular perimeter.

The inner region 44a of the seat contact surface 44 provides a seat for the cone member when the operating shaft of the joystick is in the null position. However, as the operating shaft is moved away from the null position, the lower surface of the cone member that contacts the seat contact surface 44 does so in the mid-region 44b. The curved shape of the mid-region 44b is shaped to ensure that the resistive force increases linearly as the angle of displacement increases.

The outer region 44c of the seat contact surface 44 presents a steeper surface against which the cone member is urged, and thereby a greater resistive force, when the joystick operating shaft is displaced close to its maximum angle of displacement. This feature provides an additional tactile feedback to the user and is termed an “over-press” facility. Only by providing a deliberate extra pressure on the operating shaft, will the user be able to move the operating shaft over the last few degrees before it reaches its maximum displacement.

When the operating shaft of the joystick is moved the interaction between the cone 30 and the seat contact surface 44 produces a resistive force that follows the characteristic shown in FIG. 6. After overcoming the initial static forces at A′ the resistive force rises linearly at B′ in direct proportion to the angle of displacement while the cone member 30 is urged into contact with the mid-region 44b of the seat contact surface 44. When the operating shaft is moved further so that contact between the cone member 30 and the seat contact surface 44 reaches the furthest extent of the mid-region 44b, the resistive force rises steeply at C′ due to the over-press facility described above. For the majority of the operating range of the joystick, the resistive force varies in direct proportion to the angle of displacement, thereby providing a reliable tactile feedback to the user.

It will be appreciated that the resistive forces shown in FIG. 6 are, in general the same or higher than those shown in FIG. 2 for the joystick arrangement of FIGS. 1A and 1B. Therefore over the full range of operation, the compressive and shear forces exerted on the cone member 30 will be larger. To ensure that the cone member 30 does not wear too quickly, the use of the two-material cone member 30 of FIG. 3 is greatly to be preferred.

1. A joystick controller comprising:
an operating shaft mounted for pivotal movement relative to a body, the operating shaft extending through an opening in the body; and
a bush coupled to the operating shaft and biased into contact with a contact surface of the body so as to provide a force resisting movement of the operating shaft away from a null position,
wherein the contact surface has a form configured to provide a change in the resistive force that increases linearly with an increase in angle of displacement of the operating shaft away from the null position.

2. The joystick controller of claim 1, wherein the null position is a central position, the operating shaft being mounted for pivotal movement in either direction away from the null position.

3. The joystick controller of claim 1, wherein the operating shaft is mounted for pivotal movement about two orthogonal pivot axes and the contact surface has a form that provides for a linear increase in the resistive force in whichever direction the operating shaft is displaced.

4. The joystick controller of claim 3, configured to allow the operating shaft to be displaced up to a maximum extent simultaneously in each of the orthogonal directions, such that the full range of movement of the operating shaft covers a rectangular (or square) area.

5. The joystick controller of claim 1 wherein the contact surface is configured to provide an increase in the resistive force that varies linearly with angle in any direction.

6. The joystick controller of claim 1, wherein the bush comprises a first portion of a first material in slideable engagement with the operating shaft and a second portion of a second material for contacting the contact surface.

7. The joystick controller of claim 6, wherein the first material is selected to have a low coefficient of friction with the operating shaft.

8. The joystick controller of claim 6, wherein the second material is selected to have material properties that provide a high resistance to shear and compressive forces so as to reduce wear.

9. A joystick controller comprising:
an operating shaft mounted for pivotal movement relative to a body, the operating shaft extending through an opening in the body; and
a bush coupled to the operating shaft, and biased into contact with a contact surface of the body so as to provide a force resisting movement of the operating shaft away from a null position,
wherein the bush comprises a first portion of a first material in slideable engagement with the operating shaft and a second portion of a second material for contacting the contact surface.

10. The joystick controller of claim 9, wherein the first material is selected to have a low coefficient of friction with the operating shaft.

11. The joystick controller of claim 9, wherein the second material is selected to have material properties that provide a high resistance to shear and compressive forces so as to reduce wear.

12. The joystick controller of claim 9, wherein the contact surface has a form configured to provide a change in the resistive force that increases linearly with an increase in angle of displacement of the operating shaft away from the null position.

13. A joystick controller comprising:
an operating shaft mounted for pivotal movement relative to a body; and
a bush coupled to the operating shaft and biased into contact with a contact surface of the body so as to provide a force resisting movement of the operating shaft away from a null position,
wherein the contact surface has a form configured to provide a change in the resistive force that increases with an increase in angle of displacement of the operating shaft away from the null position, and
wherein the bush comprises a portion for contacting the contact surface, said portion comprising a material selected to have material properties that provide a high resistance to shear and compressive forces so as to reduce wear.
